(19) United States
(12) Patent Application Publication
(10) Pub. No.: US 2023/0216060 A1
(43) Pub. Date: Jul. 6, 2023

(54) POSITIVE ELECTRODE FOR LITHIUM-ION BATTERY, LITHIUM-ION BATTERY AND METHOD FOR PRODUCING POSITIVE ELECTRODE FOR LITHIUM-ION BATTERY

(71) Applicant: HONDA MOTOR CO., LTD., Tokyo (JP)

(72) Inventors: Hidetoshi Utsumi, Wako-shi (JP); Shunsuke Konishi, Wako-shi (JP); Hodaka Tsuge, Wako-shi (JP); Seiichi Koketsu, Wako-shi (JP)

(21) Appl. No.: 18/089,623

(22) Filed: Dec. 28, 2022

(30) Foreign Application Priority Data
Jan. 6, 2022 (JP) 2022-001003

(51) Int. Cl. H01M 4/62; H01M 4/40; H01M 10/0525; H01M 4/04

(52) U.S. Cl. CPC H01M 4/628; H01M 4/0404; H01M 4/405; H01M 10/0525; H01M 2004/028

(57) ABSTRACT

What are provided are a positive electrode for a lithium-ion battery capable of suppressing the generation of carbon dioxide while increasing the battery capacity of the lithium-ion battery, a lithium-ion battery and a method for producing a positive electrode for a lithium-ion battery. A positive electrode for a lithium-ion battery having a positive electrode current collector and a positive electrode active material layer, in which the positive electrode active material layer has a positive electrode mixture containing the positive electrode active material, and the positive electrode mixture contains lithium carbonate in a range of 9% by mass or more and 20% by mass or less with respect of the total weight thereof.

### CROSS REFERENCE TO RELATED APPLICATION

Priority is claimed on Japanese Patent Application No. 2022-001003, filed in Japan on Jan. 6, 2022, the entire content of which is incorporated herein by reference.

### BACKGROUND OF THE INVENTION

### Field of the Invention

The present invention relates to a positive electrode for a lithium-ion battery, a lithium-ion battery and a method for producing a positive electrode for a lithium-ion battery.

### Description of Related Art

A capacitor that supplies power to motors and the like is mounted in vehicles such as electric vehicles (EVs) or hybrid electrical vehicles (HEVs). Ordinarily, a plurality of secondary batteries are provided in a capacitor.

As secondary batteries that are mounted in EVs or HEVs, lithium-ion batteries (LIBs) are in wide use. A lithium-ion battery is lightweight and capable of providing a high energy density and is thus preferably used as an in-vehicle high-output power supply.

For in-vehicle lithium-ion batteries, there is a desire to improve the energy efficiency by increasing the battery capacity as much as possible in order to realize long-distance running only with a single charge.

As one of the methods for such an increase in the battery capacity of lithium-ion batteries, the use of lithium carbonate (Li₂CO₃) as one of the configuration materials of a positive electrode active material has been proposed (for example, refer to Patent Documents 1 and 2).

Patent Documents 1 and 2 disclose non-aqueous electrolyte secondary batteries in which the use of lithium carbonate as a positive electrode active material for a lithium-ion battery suppresses a decrease in the battery capacity over time, which makes it possible to maintain a large battery capacity over a long period of time.

### Patent Documents

[Patent Document 1] Japanese Unexamined Patent Application, First Publication No. 2001-167767
[Patent Document 2] Japanese Unexamined Patent Application, First Publication No. 2002-117843

### SUMMARY OF THE INVENTION

However, in the non-aqueous electrolyte secondary batteries disclosed in Patent Documents 1 and 2, there has been a problem in that the battery capacity-increasing effect is limited since the upper limit of the amount of lithium carbonate added to a positive electrode mixture is 8.0% by mass.

This invention has been made in consideration of the above-described problem, and an objective of the present invention is to provide a positive electrode for a lithium-ion battery capable of suppressing the generation of carbon dioxide while improving the energy efficiency by increasing the battery capacity of the lithium-ion battery, a lithium-ion battery and a method for producing a positive electrode for a lithium-ion battery.

With the above-described background, the present inventor newly found an appropriate proportion of lithium carbonate added to a positive electrode mixture at which the battery capacity of a lithium-ion battery is increased and the generation of carbon dioxide can be suppressed.

That is, a positive electrode for a lithium-ion battery of the present invention is a positive electrode for a lithium-ion battery having a positive electrode current collector and a positive electrode active material layer, in which the positive electrode active material layer has a positive electrode mixture containing a positive electrode active material, and the positive electrode mixture contains lithium carbonate in a range of 9% by mass or more and 20% by mass or less with respect of the total weight thereof.

According to the present invention, it becomes possible to increase the battery capacity of the lithium-ion battery by lithium carbonate being contained in the positive electrode mixture configuring the positive electrode active material layer in a range of 9% by mass or more and 20% by mass or less with respect to the total weight of the positive electrode mixture. In addition, it is possible to reduce an increase in the amount of carbon dioxide generated by a battery reaction even when lithium carbonate is added to the positive electrode mixture in the above-described range.

In addition, in the present invention, the positive electrode mixture may contain the lithium carbonate, a lithium-nickel-manganese-cobalt (NMC) positive electrode material, carbon black and a resin binder.

A lithium-ion battery of the present invention has the positive electrode for a lithium-ion battery described in each of the above-described sections, a negative electrode having a negative electrode current collector and a negative electrode active material layer and facing the positive electrode and an electrolyte layer disposed between the positive electrode and the negative electrode.

A method for producing a positive electrode for a lithium-ion battery of the present invention is a method for producing the positive electrode for a lithium-ion battery described in each of the above-described sections, the method having a kneading step of obtaining a kneaded material by adding and kneading the lithium carbonate, the lithium-nickel-manganese-cobalt (NMC) positive electrode material, the carbon black, the resin binder and an organic solvent and a positive electrode active material layer-forming step of forming the positive electrode active material layer by applying the kneaded material to the positive electrode current collector and volatilizing the organic solvent.

According to the present invention, it becomes possible to provide a positive electrode for a lithium-ion battery capable of suppressing the generation of carbon dioxide while improving the energy efficiency by increasing the battery capacity of the lithium-ion battery, a lithium-ion battery and a method for producing a positive electrode for a lithium-ion battery.

### BRIEF DESCRIPTION OF THE DRAWINGS

FIG. 1 is a schematic cross-sectional view showing an example of the layer configuration of a lithium-ion battery of the present embodiment.

FIG. 2 is a graph showing the measurement results (verification examples) of the capacity densities of lithium-ion batteries.

FIG. 3 is a graph showing the measurement results (verification example) of the amounts of carbon dioxide generated in positive electrodes of lithium-ion batteries.

### DETAILED DESCRIPTION OF THE INVENTION

Hereinafter, a positive electrode for a lithium-ion battery, a lithium-ion battery and a method for producing a positive electrode for a lithium-ion battery of one embodiment of the present invention will be described. The embodiment to be described below is simply a specific description for better understanding of the gist of the invention and does not limit the present invention unless particularly otherwise described. In addition, in some of the drawings to be used in the following description, a portion, which is a main portion, is shown in an enlarged manner for convenience in order to facilitate the understanding of the characteristics of the present invention, and the dimensional ratio and the like of each configuration element are not always the same as those in actual cases.

### (Positive Electrode for Lithium-Ion Battery and Lithium-Ion Battery)

The configuration of a lithium-ion battery including the positive electrode for a lithium-ion battery of one embodiment of the present invention will be described.

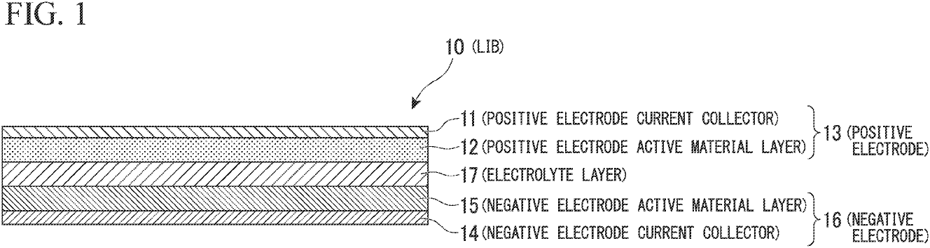

FIG. 1 is a schematic cross-sectional view showing an example of the layer configuration of the lithium-ion battery.

In a lithium-ion battery (LIB) 10, a positive electrode 13 having a positive electrode current collector 11 and a positive electrode active material layer 12 positioned on one surface of this positive electrode current collector 11, a negative electrode 16 having a negative electrode current collector 14 and a negative electrode active material layer 15 positioned on one surface of this negative electrode current collector 14 and facing the positive electrode 13, and an electrolyte layer 17 positioned between the positive electrode 13 and the negative electrode 16 are laminated.

The positive electrode active material layer 12 is a layer containing a positive electrode mixture. The positive electrode mixture has a positive electrode active material, lithium carbonate, a conductive auxiliary agent and a binder.

As the positive electrode active material, an electrode active material enabling the reversible progress of the storage and release of ions, the deintercalation and intercalation of ions or the doping and de-doping of ions and counter anions of the ions (for example, PF₆⁻) can be used.

Specific examples of the positive electrode active material include lithium cobalt oxide (LiCoO₂), lithium nickel oxide (LiNiO₂), lithium manganese dioxide (LiMnO₂), lithium manganese spinel (LiMn₂O₄), composite metal oxides represented by a general formula: LiNiₓCo_{y}Mn_{z}MₐO₂ (x + y + z + a = 1, 0 ≤ x < 1, 0 ≤ y < 1, 0 ≤ z < 1, 0 ≤ a < 1 and M is one or more elements selected from Al, Mg, Nb, Ti, Cu, Zn and Cr) (ternary compound), a lithium vanadium compound (LiV₂O₅), olivine-type LiMPO₄ (here, M represents one or more elements selected from Co, Ni, Mn, Fe, Mg, Nb, Ti, Al and Zr or VO), lithium titanate (Li₄Ti₅O₁₂), a composite metal oxide such as LiNiₓCo_{y}Al_{z}O₂ (0.9 < x + y + z < 1.1), polyacetylene, polyaniline, polypyrrole, polythiophene, polyacene and the like.

In the present embodiment, as the positive electrode active material that is contained in the positive electrode mixture, a ternary compound containing Ni, Co and Mn was used.

In the positive electrode mixture configuring the positive electrode active material layer 12 of the present embodiment, lithium carbonate (Li₂CO₃) is contained. Lithium carbonate is capable of increasing the battery capacity of the lithium-ion battery 10. In the present embodiment, lithium carbonate is contained in the positive electrode mixture in a range of 9% by mass or more and 20% by mass or less with respect to the total weight of the positive electrode mixture.

When the proportion of lithium carbonate contained is less than 9% by mass, an effect of lithium carbonate to increase the battery capacity, that is, the capacity density, of the lithium-ion battery 10 is limited. Such a capacity density is preferably, for example, 180 mAh/g or higher.

In addition, when the proportion of lithium carbonate contained is more than 20% by mass, a decrease in the capacity density begins to increase.

In addition, when the amount of the lithium carbonate added to and contained in the positive electrode mixture is large, the generation of carbon dioxide is suppressed.

When lithium carbonate is added to the positive electrode mixture in the above-described range as in the present embodiment, not only lithium ions in the electrolyte layer but also lithium contained in lithium carbonate secondarily contribute to a battery reaction and increase the capacity density.

As the binder contained in the positive electrode mixture of the positive electrode active material layer 12, a well-known binder can be used. Examples thereof include polyvinylidene fluoride (PVDF), polytetrafluoroethylene (PTFE), tetrafluoroethylene-hexafluoropropylene copolymers (FEP), tetrafluoroethylene-perfluoroalkyl vinyl ether copolymers (PFA), ethylene-tetrafluoroethylene copolymers (ETFE), polychlorotrifluoroethylene (PCTFE), ethylene-chlorotrifluoroethylene copolymers (ECTFE), and fluororesins such as polyvinyl fluoride (PVF).

Examples of the conductive auxiliary agent contained in the positive electrode mixture of the positive electrode active material layer 12 include carbon powders such as carbon blacks, carbon nanotubes, carbon materials, fine metal powders of copper, nickel, stainless steel or iron, mixtures of a carbon material and a fine metal powder and conductive oxides such as ITO.

In the positive electrode mixture configuring the positive electrode active material layer 12 of the present embodiment, among carbon blacks, ketjenblack that is excellent particularly in terms of a conductive property is used.

Regarding the conductive auxiliary agent, in a case where a sufficient conductive property can be ensured only with the positive electrode mixture, the positive electrode mixture may not contain the conductive auxiliary agent.

The negative electrode active material layer 15 has a negative electrode active material and a binder as a negative electrode mixture and has a conductive auxiliary agent as necessary. As the negative electrode active material, a well-known negative electrode active material can be used. Examples of the negative electrode active material include metallic lithium, carbon materials such as graphite capable of storing and releasing lithium ions (natural graphite and artificial graphite), carbon nanotubes, non-graphitizable carbon, graphitizable carbon and low-temperature calcined carbon, metals capable of forming a compound with lithium such as aluminum, silicon and tin, amorphous compounds mainly containing an oxide such as SiOₓ (0 < x < 2) or tin dioxide and particles containing lithium titanate (Li₄Ti₅O₁₂) or the like.

As the conductive auxiliary agent and the binder contained in the negative electrode mixture, the same conductive auxiliary agent and binder as those contained in the positive electrode active material layer 12 can be used. As the binder used in the negative electrode mixture, in addition to those contained in the positive electrode active material layer 12, for example, carboxymethyl cellulose (CMC), styrene-butadiene rubber (SBR), polyimide (PI), polyamide-imide (PAI), polyacrylic acid (PAA) and the like can also be used.

The potential of the negative electrode 16 containing such a negative electrode active material layer 15 changes due to lithium ions entering between layers in a carbon material, which is an example of the negative electrode active material, at the time of charging the lithium-ion battery 10.

According to the positive electrode 13 of the lithium-ion battery 10 of the present embodiment having such a configuration and the lithium-ion battery 10 for which this positive electrode is used, lithium carbonate is contained in the positive electrode mixture configuring the positive electrode active material layer 12 in a range of 9% by mass or more and 20% by mass or less with respect to the total weight of the positive electrode mixture, whereby it becomes possible to increase the battery capacity of the lithium-ion battery 10 compared with a case where lithium carbonate is not added.

In addition, even when lithium carbonate is added to the positive electrode mixture in the above-described range, the battery reaction does not increase the amount of carbon dioxide generated, and a configuration for gas release is not required.

Since such lithium carbonate is relatively inexpensive, it is possible to realize a positive electrode for a lithium-ion battery capable of increasing the battery capacity with a simple configuration at a low cost and a lithium-ion battery for which the positive electrode is used.

### (Method for Producing Positive Electrode for Lithium-Ion Battery)

One embodiment of a method for producing the positive electrode for a lithium-ion battery having the above-described configuration will be described. At the time of producing a positive electrode for a lithium-ion battery by the method for producing the positive electrode for a lithium-ion battery of the present embodiment, first, the positive electrode mixture is prepared.

For example, LiCoNiMnO₆ (NMC), which is a ternary oxide, as the negative electrode active material, lithium carbonate, ketjenblack as the conductive auxiliary agent and polyvinylidene fluoride (PVdF) as the binder are each used, and, as an organic solvent, N-methyl-2-pyrrolidone (NMP) is added to and kneaded with these powders to obtain a kneaded material (kneading step).

Next, the obtained slurry-form kneaded material is applied to the positive electrode current collector, for example, an aluminum thin film. In addition, the kneaded material applied to this aluminum thin film is dried to volatilize the organic solvent, whereby the positive electrode for a lithium-ion battery of the present embodiment can be obtained (positive electrode active material-forming step).

Hitherto, the embodiments of the present invention have been described, but such embodiments are proposed as examples and do not intend to limit the scope of the invention. Such embodiments can be carried out in a variety of other forms and can be omitted, substituted, or modified in a variety of manners within the scope of the gist of the invention. These embodiments or modifications thereof are included in the inventions described in the claims and the equivalent scope thereof in the same manner as being included in the scope or gist of the invention.

### EXAMPLES

### Verification of Capacity Density

As an example of the present invention, the relationship between the amount of lithium carbonate contained in a positive electrode mixture and the capacity density of a lithium-ion battery was verified.

For the lithium-ion batteries used in the verification, aluminum thin films were used as positive electrode current collectors and negative electrode current collectors, respectively, positive electrode mixtures and negative electrode mixtures were applied to these aluminum thin films, respectively, and positive electrode active material layers and negative electrode active material layers were formed, respectively.

### (Positive Electrodes)

For the positive electrode mixtures, LiCoNiMnO₆ (NMC), lithium carbonate, ketjenblack (KB) and polyvinylidene fluoride (PVdF) were each used.

The proportions (A:B:C:D (% by mass)) of NMC (A), KB (B), PVdF (C) and lithium carbonate (C) contained and used for the verification are shown below.
Example 1: 81:5:5:9
Example 2: 75:5:5:15
Example 3: 70:5:5:20
Comparative Example 1: 90:5:5:0
Comparative Example 2: 87:5:5:3
Comparative Example 3: 60:5:5:30

As an organic solvent, 100 µL of NMP was added to each of the positive electrode mixtures having these proportions, and three-minute kneading at a kneading rate of 1000 rpm was repeated four times using a degassing kneader (AWATORI RENTARO: manufactured by THINKY Corporation). After that, furthermore, NMP was added such that the total amount added reached 400 µL, three-minute kneading was carried out once at a kneading rate of 1000 rpm, and a kneaded material for each specimen was obtained.

Next, the obtained slurry-form kneaded material of each specimen was applied to the aluminum thin film using a coating machine including a blade with a coating layer gap of 100 µm (blade coater). In addition, the aluminum thin film coated with the kneaded material was dried at 80° C. in an atmospheric pressure environment for two hours, then, dried in a vacuum at 120° C. for 12 hours to volatilize the organic solvent and then blanked into a disc shape with a diameter of 16 mm, thereby obtaining a positive electrode for each specimen.

### (Negative Electrode)

As a negative electrodes, lithium metal foils were used.

### (Electrolyte Layers)

An electrolytic solution was made by dissolving lithium hexafluorophosphate (LiPF₆) in a solvent obtained by mixing ethylene carbonate (EC) and ethyl methyl carbonate (EMC) in a mass ratio of 3:7 such that the concentration reached 1 M/L, and sheet-like porous base materials were impregnated with this electrolytic solution, thereby obtaining electrolyte layers.

A lithium-ion battery used for the verification was made by laminating such positive electrode, negative electrode and electrolyte layer.

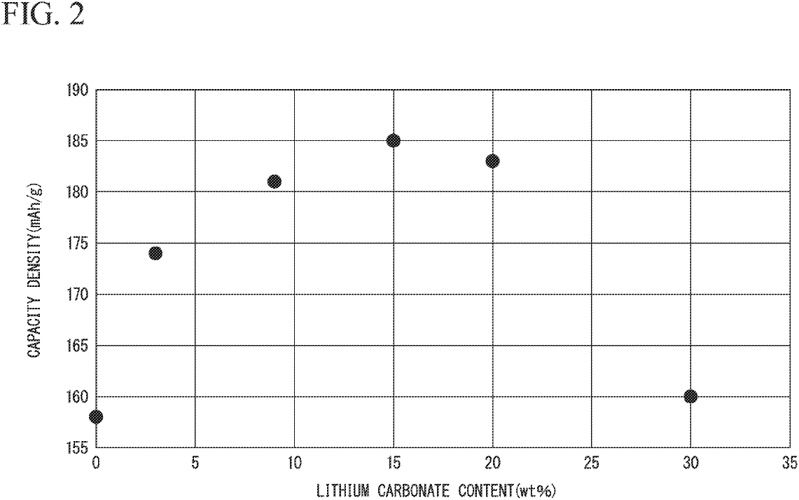

The measurement results of the capacity densities of the lithium-ion batteries made using the above-descried positive electrodes of Present Invention Example 1 to 3 and Comparative Examples 1 to 3 are shown by a graph in FIG. 2.

According to the results shown in FIG. 2, it was confirmed that, in the lithium-ion batteries for which the positive electrodes of Examples 1 to 3 containing lithium carbonate in a range of 9% by mass or more and 20% by mass or less with respect to the total weight of the positive electrode mixture were used, the capacity densities were all 180 mAh/g or higher and high battery capacities could be realized.

On the other hand, in the lithium-ion batteries for which a positive electrode containing no lithium carbonate and the positive electrodes of Comparative Examples 1 to 3 containing 3% by mass or 30% by mass of lithium carbonate with respect to the total weight of the positive electrode mixture were used, the capacity densities were all lower than 175 mAh/g and there was no or small battery capacity-increasing effect.

From the above results, it was possible to confirm the battery capacity-increasing effect of the present invention.

### Verification of Amount of Carbon Dioxide Generated by Addition of Lithium Carbonate

As an example of the present invention, the relationship between the amount of lithium carbonate contained in the positive electrode mixture and the amount of carbon dioxide gas, as a representative example of carbon dioxide, generated was verified.

As positive electrodes for lithium-ion batteries used for the verification, the positive electrodes of Example 1 and Comparative Examples 1 and 2 used for the above-described verification of the capacity densities were used. In addition, voltages of 3.8 V, which is equal to or lower than the decomposition voltage of lithium carbonate, and 4.3 V, which is higher than 4.2 V, which is the decomposition voltage of lithium carbonate, were applied to each of the positive electrodes for the lithium-ion batteries, and the concentrations of carbon dioxide gases generated were measured. The concentrations of carbon dioxide gases were measured using gas chromatography.

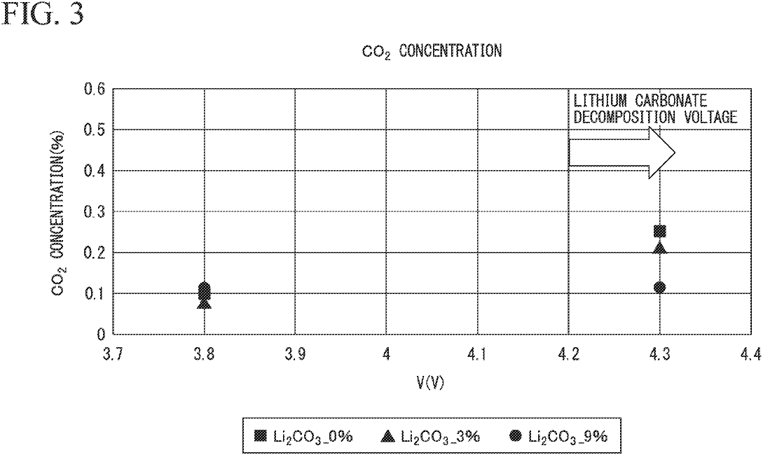

The relationship between the amount of lithium carbonate added and the amount of the carbon dioxide gas generated is shown by a graph in FIG. 3.

According to the results shown in FIG. 3, at the applied voltage of 4.3 V, the amount of the carbon dioxide gas generated was lower in Example 1 where 9% by mass of lithium carbonate was added to the positive electrode mixture than in Comparative Example 1 where lithium carbonate was not added or Comparative Example 2 where 3% by mass of lithium carbonate was added.

Therefore, according to the present invention, it was possible to confirm that, in a case where a positive electrode containing lithium carbonate in a range of 9% by mass or more and 20% by mass or less with respect to the total weight of a positive electrode mixture is used in order to increase the battery capacity, the amount of carbon dioxide gas generated can also be suppressed.

The positive electrode for a lithium-ion battery, the lithium-ion battery and the method for producing the positive electrode for a lithium-ion battery of the present invention satisfy both an increase in the battery capacity and the suppression of the amount of carbon dioxide gas generated. Lithium-ion batteries for which such a positive electrode for a lithium-ion battery is used make it possible to realize long-distance running only with a single charge and improve the energy efficiency when used as secondary batteries for vehicles such as EVs or HEVs. Therefore, the present invention is highly industrially applicable.

While preferred embodiments of the invention have been described and illustrated above, it should be understood that these are exemplary examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10 Lithium-ion battery
11 Positive electrode current collector
12 Positive electrode active material layer
13 Positive electrode
14 Negative electrode current collector
15 Negative electrode active material layer
16 Negative electrode
17 Electrolyte layer

What is claimed is:

1. A positive electrode for a lithium-ion battery comprising:
a positive electrode current collector; and
a positive electrode active material layer,
wherein the positive electrode active material layer has a positive electrode mixture containing a positive electrode active material, and the positive electrode mixture contains lithium carbonate in a range of 9% by mass or more and 20% by mass or less with respect of a total weight thereof.

2. The positive electrode for a lithium-ion battery according to claim 1,
wherein the positive electrode mixture contains the lithium carbonate, a lithium-nickel-manganese-cobalt (NMC) positive electrode material, carbon black and a resin binder.

3. A lithium-ion battery comprising:
the positive electrode for a lithium-ion battery according to claim 1;
a negative electrode having a negative electrode current collector and a negative electrode active material layer and facing the positive electrode; and
an electrolyte layer disposed between the positive electrode and the negative electrode.

4. A lithium-ion battery comprising:
the positive electrode for a lithium-ion battery according to claim 2;
a negative electrode having a negative electrode current collector and a negative electrode active material layer and facing the positive electrode; and
an electrolyte layer disposed between the positive electrode and the negative electrode.

5. A method for producing the positive electrode for a lithium-ion battery according to claim 2, the method comprising:
a kneading step of obtaining a kneaded material by adding and kneading the lithium carbonate, the lithium-nickel-manganese-cobalt (NMC) positive electrode material, the carbon black, the resin binder and an organic solvent; and
a positive electrode active material layer-forming step of forming the positive electrode active material layer by applying the kneaded material to the positive electrode current collector and volatilizing the organic solvent.
